(19) United States
(12) Patent Application Publication
(10) Pub. No.: US 2012/0147714 A1
(43) Pub. Date: Jun. 14, 2012

(54) GEOMETRICAL-FIGURE TIME DISPLAY

(76) Inventor: Yaron Chaut, Ramat Gan (IL)

(21) Appl. No.: 12/962,675

(22) Filed: Dec. 8, 2010

(51) Int. Cl. G04C 17/02; G04C 19/02

(52) U.S. Cl. 368/240; 368/239; 368/241; 368/242

(57) ABSTRACT

A clock configured to display time as a cumulative sum of time display areas of various shapes arranged in various arrangements. The clock is also configured to display complete and fractional hours in any single display area capable of being activated in a random order.

### FIELD AND BACKGROUND OF THE INVENTION

The present invention relates to the display of time and, in particular, it is concerned with the display of time by way of fractional geometrical figures.

From nearly the beginning of the civilization, man has been fascinated by time and has created a vast multitude of instruments to keep and display it.

Early clocks tracked the apparent movement of the sun across the sky by the shadow cast on a sundial or the passage of a fixed amount of water or sand passing through an opening.

In more recent times, mechanical clocks, driven by weights, springs and/or electrical energy, have been widely used. These mechanical clocks typically feature a clock face having time demarcations. A number of hands rotatable at different angular velocities around a common axis are rotate over the clock face. Each hand rotates at different predefined rates indicating the passage of hours, minutes, and seconds.

Most recently, these analog clocks have been replaced in part by electronic clocks featuring electronic digital time display, thereby obviating the need for rotating hands.

While electronic digital display clocks are suitable for many purposes, there is considerable feeling that analog clocks, which display the time by way of spatial relationships are easier to read.

The state-of-the-art of digital clock and watch technologies include: LED or OLED displays, electronic ink displays, LCD displays. These technologies are capable of showing time as digital numbers, as binary dots, as a digital simulation of analog clock hands, etc.

There remains a need, and it would be advantageous to have, additional ways of displaying time using a timepiece, or clock, having no rotating hands.

### SUMMARY OF THE INVENTION

The present invention is a clock configured to display time by way of the area enclosed within various geometrical figures.

According to the teachings of the present invention there is provided a clock comprising: (a) a time measuring mechanism; and (b) a plurality of electronic display areas for displaying a passage of time measured by the time measuring mechanism, each of the display areas being configured to be progressively activated in direct proportion to a gradual passage of one hour of time, thereby displaying a partial or a complete hour in any of the time display areas.

According to a further feature of the present invention, the each of the display areas are further configured to blink each second, thereby also displaying seconds on any one of the display areas.

According to a further feature of the present invention, the plurality of display areas are arranged in an array so as to form upon activation any dot pattern found on a domino block.

According to a further feature of the present invention, there is also provided one time display bar configured to indicate each second measured by the time measuring mechanism.

According to a further feature of the present invention, the plurality of display areas are disposed on two, spatially separate, display faces, the display areas being in operative communication with each other so as to collectively display a time.

According to a further feature of the present invention, the display areas are arranged in an array analogous to a six dot arrangement of a die.

According to a further feature of the present invention, the plurality of time display areas is arranged in a substantially straight line.

According to a further feature of the present invention, the time display areas are circular.

According to a further feature of the present invention, the time display areas are polygonal.

According to a further feature of the present invention, the time display areas are elliptical.

According to a further feature of the present invention, the display areas include LED arrangements.

According to a further feature of the present invention, the display areas include LCD arrangements.

There is also provided according to the teachings of the present invention, a clock comprising: (a) a time measuring mechanism configured to measure a passage of time; and (b) a plurality of electronic display areas for displaying a passage of time measured by the time measuring mechanism, each of the display areas being configured to be progressively activated in direct proportion to a gradual passage of one hour of time such that a current time is displayed by a cumulative amount of activated electronic display areas.

According to a further feature of the present invention, each of the display areas are further configured to blink each second, thereby also displaying seconds on any one of the display areas.

According to a further feature of the present invention, the plurality of display is arranged in an array so as to form upon activation any dot pattern found on a domino block.

According to a further feature of the present invention, there is also provided one time display bar configured to indicate each second measured by the time measuring mechanism.

According to a further feature of the present invention, the plurality of display areas are disposed on two, spatially separate, display faces, the display areas being in operative communication with each other so as to collectively display a time.

According to a further feature of the present invention, the display areas are arranged in an array analogous to a six dot arrangement of a die.

There is also provided according to the teachings of the present invention, a clock comprising: (a) a time measuring mechanism configured to measure a passage of time; and (b) a plurality of electronic display areas for displaying a passage of time measured by the time measuring mechanism, each of the display areas being configured to be activated in a random order, wherein each of the display areas is progressively activated in direct proportion to a gradual passage of one hour of time such that a current time is displayed by a cumulative amount of activated electronic display areas.

According to a further feature of the present invention, the plurality of display areas are arranged in an array so as to form upon activation any dot pattern found on a domino block.

According to a further feature of the present invention, each of the display areas are further configured to blink each second, thereby also displaying seconds on any one of the display areas.

There is also provided according to the teachings of the present invention, a clock comprising: (a) a time measuring mechanism; and (b) a plurality of time display areas for displaying a passage of time measured by the time measuring mechanism, (c) a plurality of shutter arrangements, each of the shutter arrangements being associated with one of the time display areas, each of the shutter arrangements being configured to progressively change a quantity of one of the time display areas visible to an observer, the quantity of a time display area being in proportion to a corresponding portion of an hour having elapsed, thereby displaying a partial or a complete hour by way of any of the time display areas.

### BRIEF DESCRIPTION OF THE DRAWINGS

The invention is herein described, by way of example only, with reference to the accompanying drawings, wherein:

FIG. 1 depicts a domino time display, associated a display control unit, and timing circuitry.

FIGS. 2-2e depict a time display having display areas arranged in a domino based, dot arrangement with various options of displaying the time 7:00.

FIGS. 3-3d depict a single display area at different stages of filling corresponding to the beginning and end of a complete hour, a quarter and three quarters of an hour, respectively.

FIGS. 4-4a depict a time display having a seconds bar in a non-illuminated, and non-illuminated states, respectively.

FIGS. 5-5c depict an exemplary manner of displaying the times 5:00, 5:15, 6:00, and 6:30, respectively.

FIGS. 6-6c depict a square display area at different stages of filling corresponding to the beginning and the end of the hour, and various fractions of an hour, respectively.

FIGS. 6d-6g depict a hexagonal display area at different stages of filling corresponding to the beginning and the end of the hour, and various fractions of an hour, respectively.

FIG. 7 depicts a time display having square display areas displaying the time 7:40.

FIGS. 8-9 depict a time display having elliptical display areas displaying the times 5:40 and 8:30, respectively.

FIGS. 10-11 depict a time display having circular display areas arranged in a rectangular block displaying the times 7:25 and 4:30, respectively.

FIG. 12 depicts a time display having hexagonal display areas arranged in a line displaying the time 6:10.

FIGS. 13-14 depict a domino time display having display areas configured to fill as shading against an illuminated background during day hours and fill as illumination against a shaded background during night hours displaying the time 9:30 a.m. and p.m., respectively.

FIG. 15 depicts a series of display areas embedded in a building wall.

FIGS. 16-17 depict variants of a split time display embodiment in which two spatially separate time displays in wireless communication with a display control unit collectively display time.

FIG. 18 depicts a hard wired variant of the split time display of FIGS. 16-17.

FIG. 19 is a schematic, cross-sectional side view of a mechanical embodiment of the present invention in which time is displayed by progressively exposing a colored time display area.

FIGS. 20-20d depict a mechanical time display in progressively exposed states displaying 0.0, 0.25, 0.50, 0.75, and 1.0 hours, respectively.

### DESCRIPTION OF THE PREFERRED EMBODIMENTS

The present invention is a clock configured to display time by way of the area enclosed within various geometrical figures. The principles and operation of the method according to the present invention may be better understood with reference to the drawings and the accompanying description.

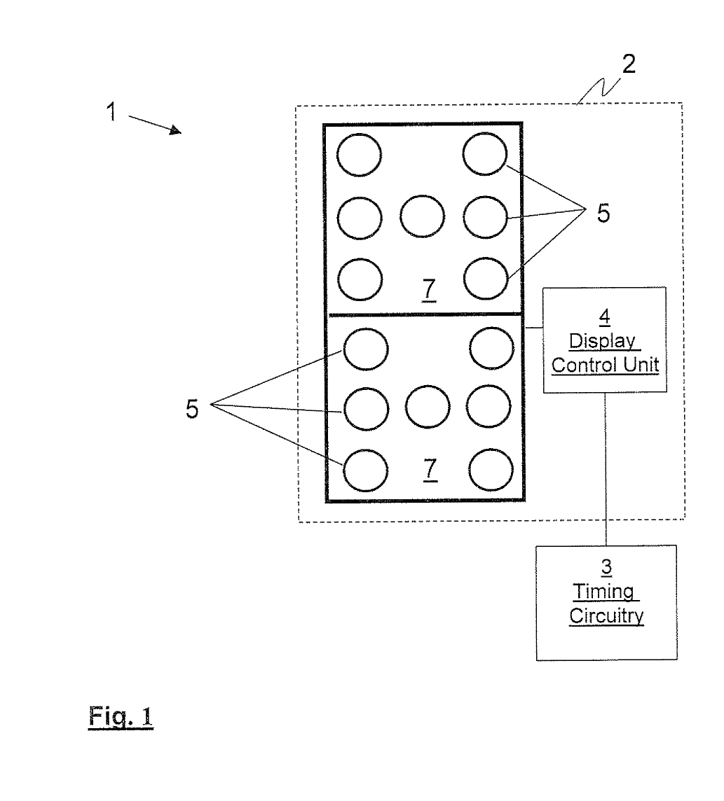

As shown in FIG. 1, clock, generally designated 1, includes time display 2 operative to display time tracked by timing mechanism 3 that in a non-limiting, exemplary embodiment is implemented as electronic circuitry; however, it should be appreciated that a timing mechanism implemented by way of software, mechanical or electric arrangements, or as an atom clock are all included within the scope of the present invention. Time display 2 includes display control unit 4 that controls the manner in which time is displayed on plurality of display areas 5 disposed on face 7 of time display 2. Each display area S is implemented in a non-limiting, exemplary embodiment, as an electronic display screen configured to display an image that progressively fills an electronic display area 5 at a rate corresponding to the passage of one hour of time as tracked by timing circuitry 3. In an exemplary, non-limiting embodiment, display area 5 fills with a color; however, it should be appreciated that electronic display areas filling in any manner with images of figures, logos that contrasts with face 7 is included within the scope of the present invention. It should be appreciated that an electronic display areas implemented as liquid-crystal display (LCD), light-emitting-diodes (LED), organic light-emitting-diodes (OLED), and electronic ink displays are all included within the scope of the present invention. Display areas configured to be progressively covered, for example, by way of electrically or spring driven shutter arrangements are also included within the scope of the present invention as will be further discussed. Furthermore, it should be appreciated that embodiments having time display areas 5 fully illuminated at the beginning of the hour and progressively deactivate the illuminated display area as a function of time are also included within the scope of the present invention. Display control unit 4 and timing mechanism 3 implemented electronically, mechanically, or by way of software or embedded software are all included within the scope of the present invention.

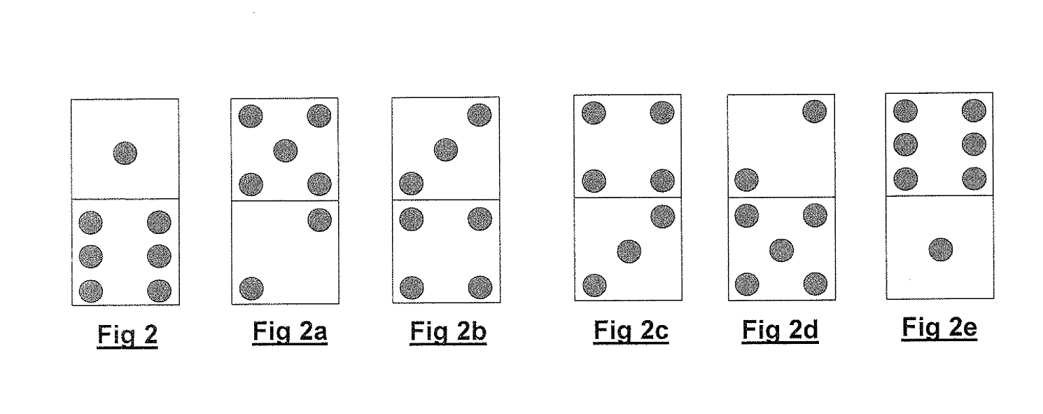

FIGS. 2-2d depict a non-limiting exemplary, embodiment of display face 7 and time display areas 5 arranged in a domino based dot arrangement displaying the time 7:00. By way of example, any combination of full activated electronic time display areas 5 that add up to seven represents 7:00. It should be noted that the present invention includes an option for displaying times by way activating display areas 5 in a pre-defined combination or in a random combination; in both instances the collective activated display areas 5 depicts the current time. Random activation means that sometimes a particular time is displayed by activation of a particular combination of display areas 5 that may or may not differ from the combination of display areas previously activated when displaying the same time.

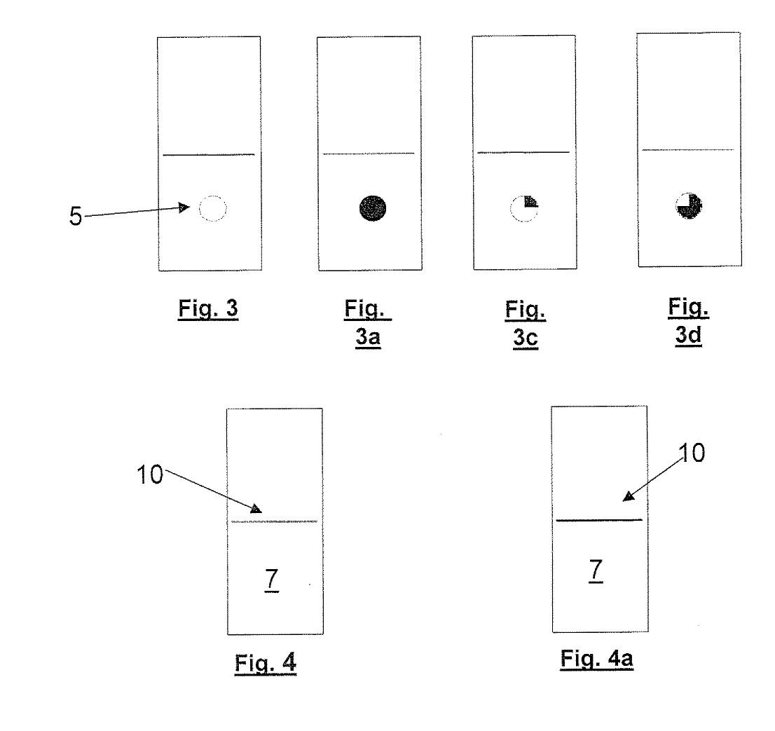

FIGS. 3-3d depict a single time display area 5 at different stages of illumination. The completely non-illuminated circle of FIG. 3 corresponds to the beginning of an hour; a fully illuminated circle of FIG. 3a corresponds to a complete hour, and the partially illuminate display areas 5 of FIGS. 3c and 3d correspond to a quarter and three quarters of an hour, respectively.

FIGS. 4-4a depict a time display having a flashing seconds bar 10 disposed in display face 7 a non-illuminated and illuminated states, respectively. Seconds bar 10 is implemented as a LED configured to flash every second in a non-limiting, exemplary embodiment. It should be appreciated that in a second, exemplary embodiment, each time display area 5 is configured to flash every second thereby advantageously displaying three different units of time; hours, fractions of hours (i.e. minutes), and seconds.

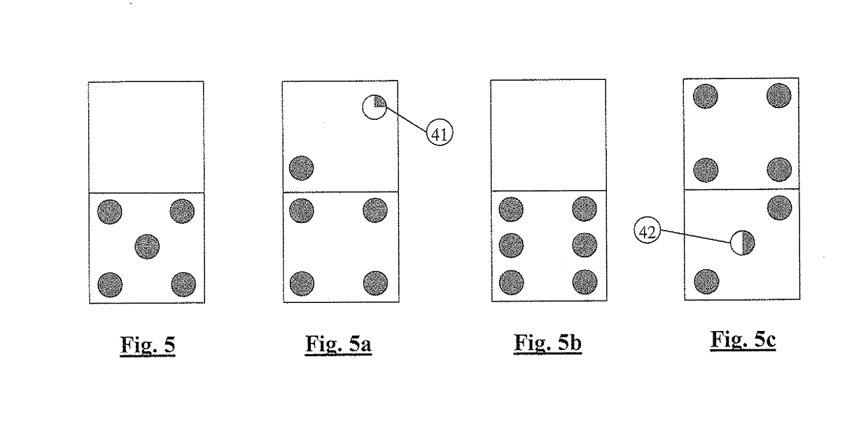

FIGS. 5-5c depict a progression of time from 5:00-6:30. At 5:00 there are exactly five fully illuminated time display areas 5. At 5:15, there are still five fully illuminated time display areas 5 that are not necessarily identical to those illuminated at 5:00 plus one additional time display area 41 25% illuminated. At 6:00, there are exactly six time display areas 5 fully illuminated; but again, not those necessarily illuminated at 5:15, and finally, at 6:30, there are six time display areas 5 fully illuminated, different than those illuminated at 6:00 plus one additional time display area 42 illuminated 50%.

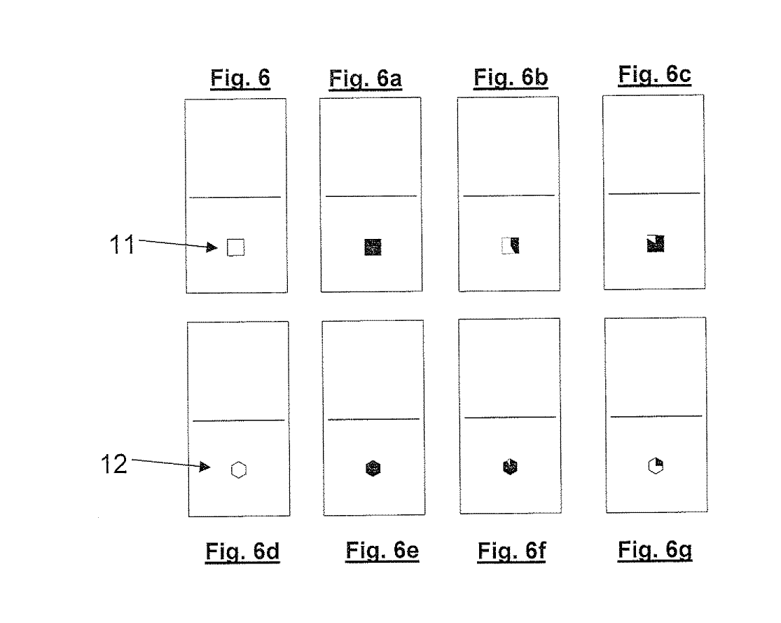

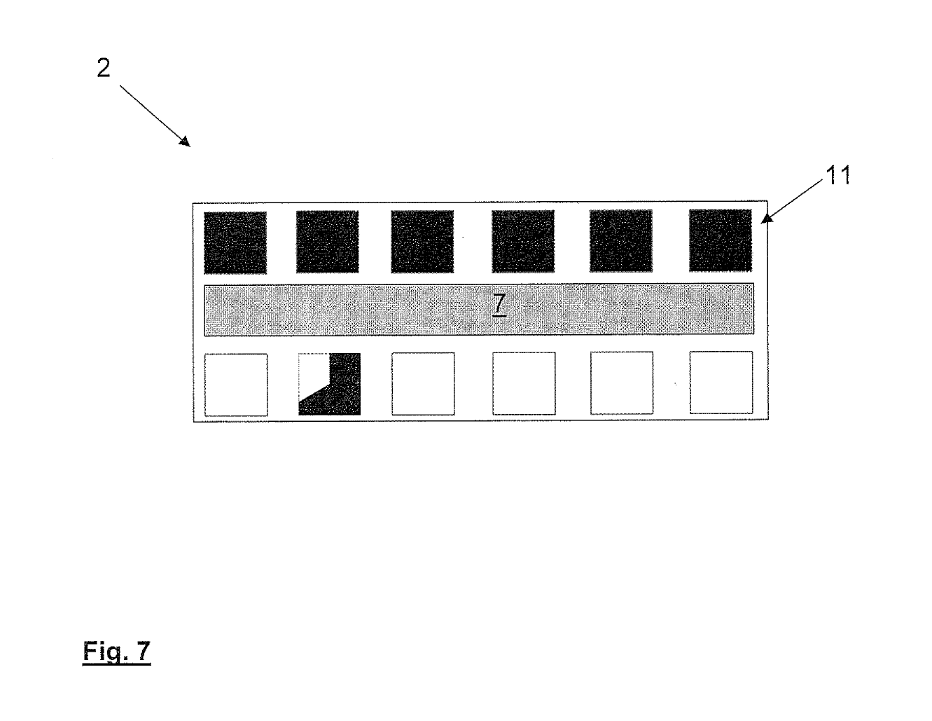

FIGS. 6-6c depict an alternative embodiment in which the time display areas are implemented as squares 11 and FIGS. 6d-6g depict an alternative embodiment in which the time display areas are implemented as hexagons 12. In the same manner describe above hours are displayed by entirely illuminated time display areas and minutes are displayed as fractions of a time display area. It should be noted that embodiments in which display areas illuminated in 15 minute increments for square display areas 11, 12 minute increments for hexagonal display areas 12, or any other increment are included within the scope of the present invention. FIG. 7 depicts the above-described embodiment having time display areas implemented as squares displaying the time of 7:40.

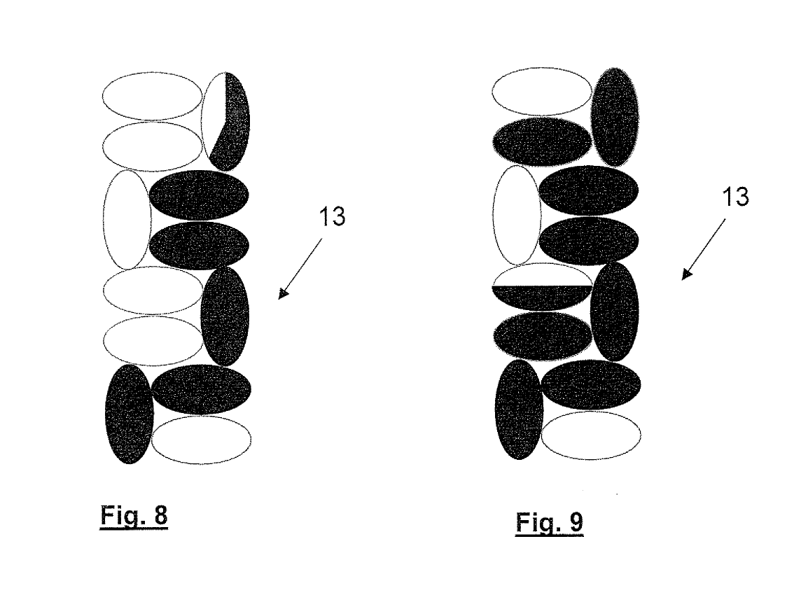

FIGS. 8 and 9 depict an alternative embodiment in which time display areas are implemented as ellipses 13 depicting the time of 4:40 and 8:30, respectively.

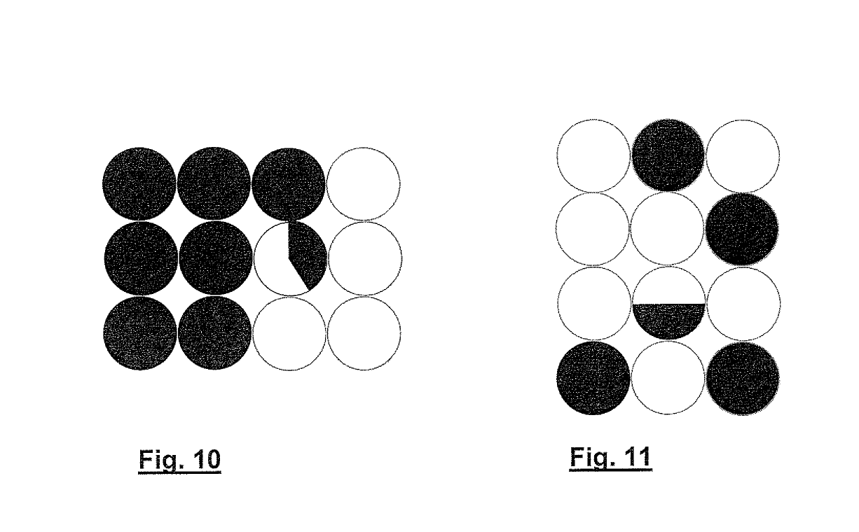

FIGS. 10 and 11 depict a time display having circular time display areas 5 arranged in a rectangular block displaying the times 7:25 and 4:30, respectively. It should be appreciated that time display areas arranged in any arrangement are included within the scope of the present invention.

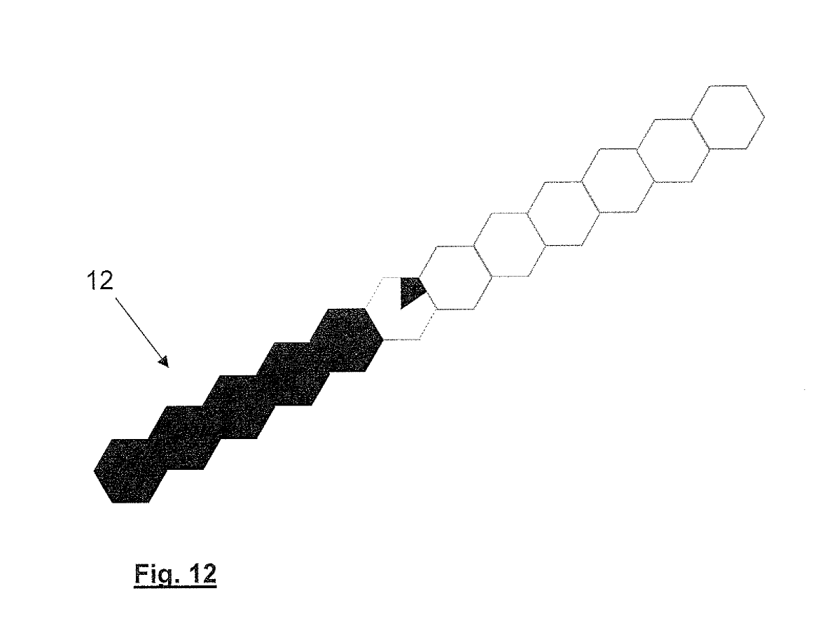

FIG. 12 depicts a time display having hexagonal display areas 12 arranged in a line displaying the time 6:10. It should be appreciated that any combination of the features described within this document are included within the scope of the present invention. For example, embodiments having display areas in the shape of hexagons arranged as domino arrangements included within the scope of the present invention.

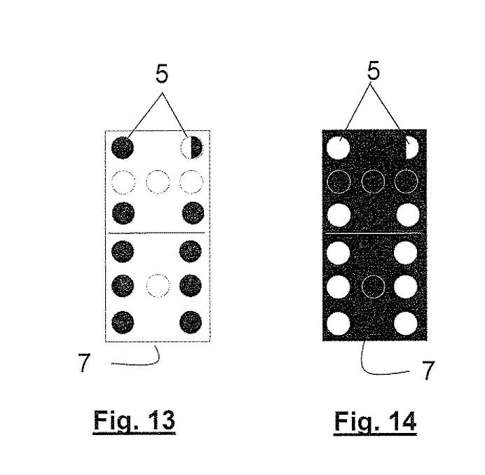

FIGS. 13-14 depict a domino time display having a display face 7 configured to be illuminated during daylight hours and to be non-illuminated during nighttime hours. This feature is implemented by way of a translucent display face 7 and a background LED disposed inside the display housing (not shown) in a non-limiting, exemplary embodiment. The LED is activated to illuminate display face 7 during daylight hours by way of a an integrated light detector configured to activate the background LED when ambient light is reduced to a predefined threshold during evening hours and is deactivated when ambient daylight reaches a predefined threshold in the morning hours in a non-limiting, exemplary embodiment. Time display areas 5 are illuminated in a manner during each of these periods so as to produce sufficient contrast between them and background of the display face 7 and therefore time display areas 5 include both LCD and LED arrangements, each operative at different periods of the day. As shown in FIG. 13, during nighttime hours display face 7 is illuminated and time display areas 5 display time by shading executed by an LCD array, and as shown in FIG. 14, during daytime hours background LED is deactivated and time is displayed in time display areas 5 by illumination of LED. It should be noted that the background LED is chosen to illuminate display face 7 for a color differentiating the LED employed for time display areas 5. Furthermore, a background LED activated by way of a pre-programmed or manually set activation arrangement is included within the scope of the present invention. It should also be noted that implementations employing electronic ink or any other technology providing the above described functionality is included within the scope of the present invention.

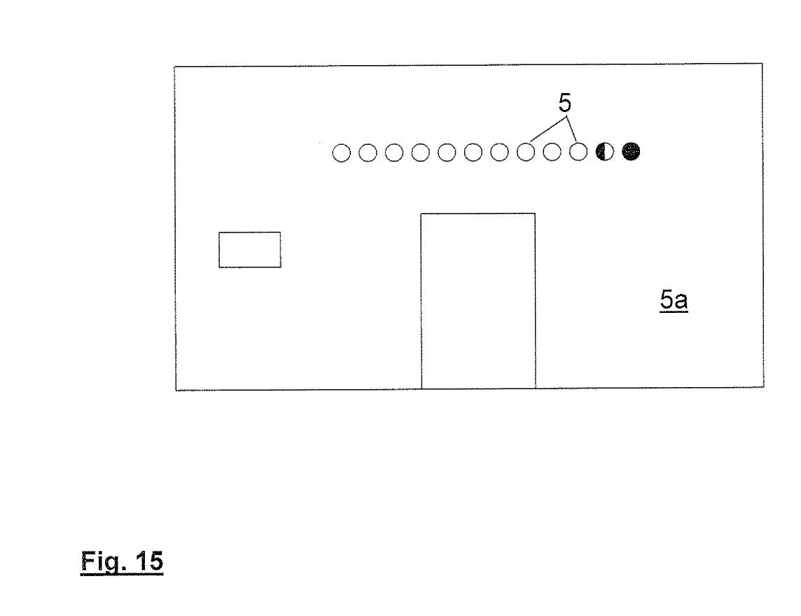

FIG. 15 depicts a series of time display areas 5 embedded directly into a wall 5a without any time display housing. It should be appreciated that series of time display areas 5 embedded directly into a structure is included within the scope of this invention.

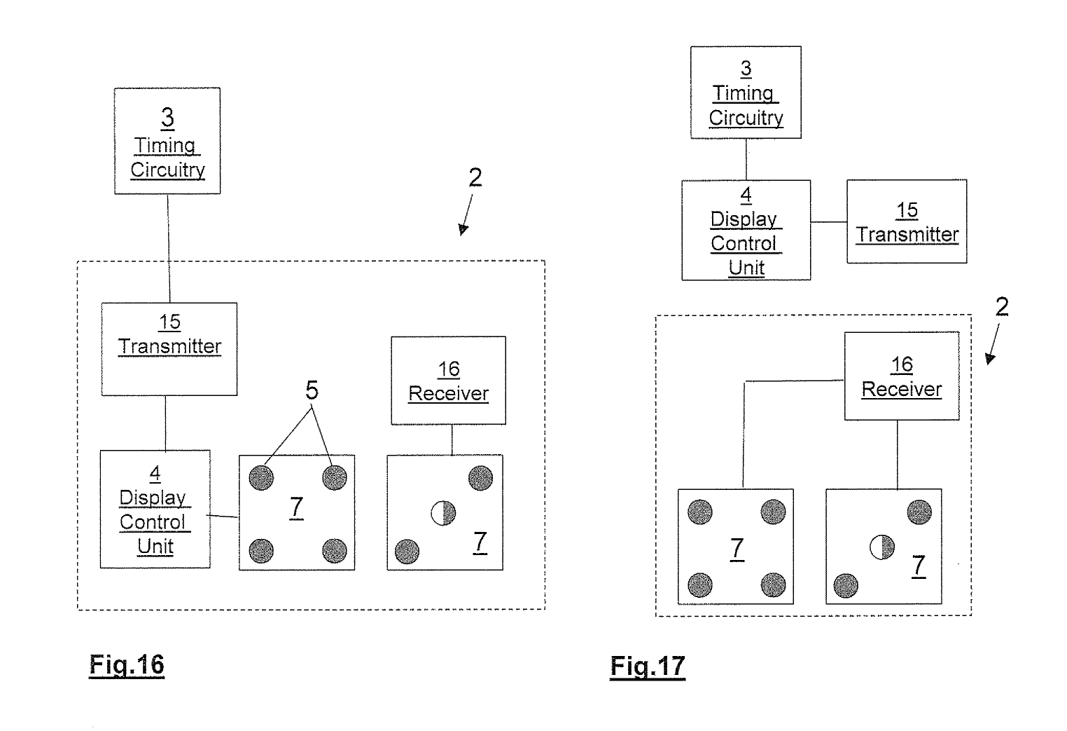

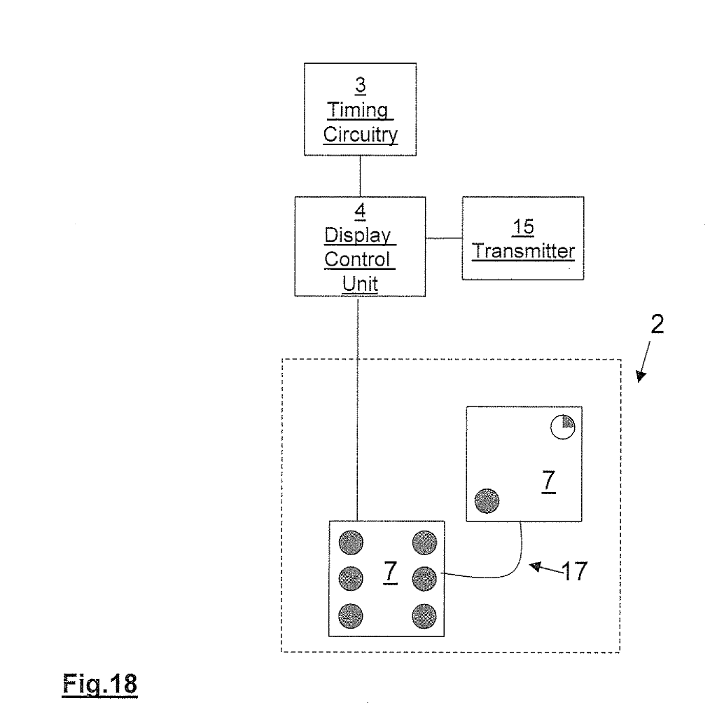

FIGS. 16-17 depict a time display 2 having time displace areas 5 disposed on face 7 in a manner similar to the dot arrangement of dice. Given that dice have a maximum of six dots on one of the faces; time display 2 is split into two spatially separate display faces 7 containing six time display areas 5 to collectively display time. Wireless, data transfer between display areas 5 disposed in each display face 7 is synchronized by way of display control unit 4 and a transmitter 15 disposed in either display face 7 and a receiver 16 disposed in the remaining display face 7. Alternatively, display areas 5 are synchronized by way of a common receiver 16 in wireless communication with remotely disposed, display control unit 4 and transmitter 15. It should be noted that any frequency of transmission suitable for such arrangements is included within the scope of the present invention. Embodiments in which display synchronization is accomplished by way of a hard-wired arrangement are also enclosed within the scope of the present invention as shown if FIG. 17, designation 17.

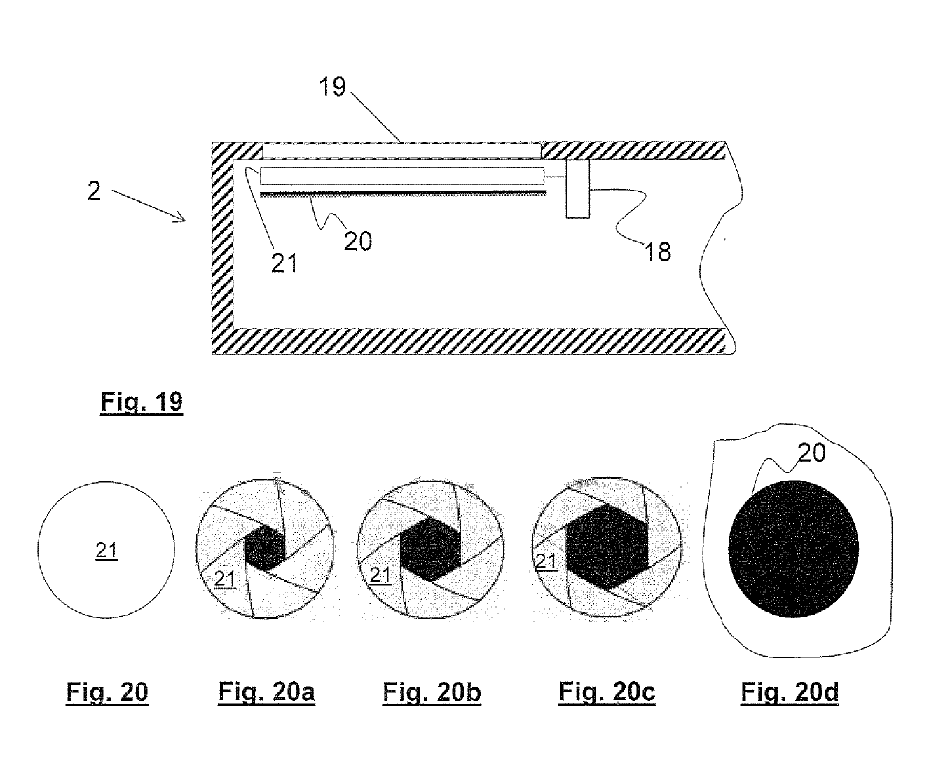

FIGS. 19-20d depicts a non-limiting alternative embodiment of one of a plurality of mechanical time displays disposed in displace face 7. Transparent window 19 provides visual access to a shutter arrangement 21 disposed between window 19 and colored time display area 20. Shutter arrangement 21 is driven by electric motor 18 such that shutter 18 progressively exposes colored time display area 20 in proportion to a corresponding passage of time. At the beginning of the hour shutter 21 entirely covers colored time display area 20 and progressively exposes colored time display area as shown in states displaying 0.0, 0.25, 0.50, 0.75, and 1.0 hours, respectively. Shutter arrangement 21 associated with each time display area 20 is configured to either remain in an entirely retracted state at the end of an hour or to reassume a default state entirely covering time display area 20. The particular state in which shutter arrangement 21 assumes at the end of an hour is determined by the particular combination of display areas 20 to be employed for displaying the cumulative time as described above. It should be appreciated that shutter arrangements driven by spring arrangements are also included within the scope of the present invention. It should also be appreciated that embodiments configured to display time by progressively covering colored time display area 20 are included within the scope of the present invention. Furthermore, it should be noted that in non-limiting, exemplary embodiments, colored display area 20 are implemented so as to contrast with shutter color, such as a black time display area and white shutter arrangement, for example.

In non-limiting, exemplary embodiments, timing mechanism 3 and time display 2 are powered by any power source. Clock 1 is fitted with a USB connection for transferring time data from a computer in a non-limiting, exemplary embodiment. These elements are disposed inside a housing constructed of hard plastic or any other material suitable for such use. In non-limiting, exemplary models, the clock is fitted with a touch screen, or electromechanical mechanisms for setting the time, and a light sensor configured to illuminate time display areas 5 with light of different color as a function of changing ambient light conditions. It should be appreciated that the present application has application as a wrist watch, a wall clock, a screen saver, or any other application in which a user is interested in obtaining the current time.

It will be appreciated that the above descriptions are intended only to serve as examples, and that many other embodiments are possible within the scope of the present invention as defined in the appended claims.

The invention claimed is:

1. A clock comprising:
(a) a time measuring mechanism; and
(b) a plurality of electronic display areas for displaying a passage of time measured by said time measuring mechanism, each of said display areas being configured to be progressively activated in direct proportion to a gradual passage of one hour of time, thereby displaying a partial or a complete hour in any of said time display areas.

2. The clock of claim 1, wherein said each of said display areas are further configured to blink each second, thereby also displaying seconds on any one of said display areas.

3. The clock of claim 1, wherein said plurality of display areas are arranged in an array so as to form upon activation any dot pattern found on a domino block.

4. The clock of claim 1, further comprising one time display bar configured to indicate each second measured by said time measuring mechanism.

4. The clock of claim 1, wherein said plurality of display areas are disposed on two, spatially separate, display faces, said display areas being in operative communication with each other so as to collectively display a time.

5. The clock of claim 4, wherein said display areas are arranged in an array analogous to a six dot arrangement of a die.

6. The clock of claim 1, wherein said plurality of time display areas is arranged in a substantially straight line.

7. The clock of claim 1, wherein said time display areas are circular.

8. The clock of claim 1, wherein said time display areas are polygonal.

9. The clock of claim 1, wherein said time display areas are elliptical.

10. The clock of claim 1, wherein said display areas include LED arrangements.

11. The clock of claim 1, wherein said display areas include LCD arrangements.

12. A clock comprising:
(a) a time measuring mechanism configured to measure a passage of time; and
(b) a plurality of electronic display areas for displaying a passage of time measured by said time measuring mechanism, each of said display areas being configured to be progressively activated in direct proportion to a gradual passage of one hour of time such that a current time is displayed by a cumulative amount of activated electronic display areas.

13. The clock of claim 12, wherein said each of said display areas are further configured to blink each second, thereby also displaying seconds on any one of said display areas.

14. The clock of claim 12, wherein said plurality of display is arranged in an array so as to form upon activation any dot pattern found on a domino block.

15. The clock of claim 12, further comprising one time display bar configured to indicate each second measured by said time measuring mechanism.

16. The clock of claim 12, wherein said plurality of display areas are disposed on two, spatially separate, display faces, said display areas being in operative communication with each other so as to collectively display a time.

17. The clock of claim 16, wherein said display areas are arranged in an array analogous to a six dot arrangement of a die.

18. A clock comprising:
(a) a time measuring mechanism configured to measure a passage of time; and
(b) a plurality of electronic display areas for displaying a passage of time measured by said time measuring mechanism, each of said display areas being configured to be activated in a random order, wherein each of said display areas is progressively activated in direct proportion to a gradual passage of one hour of time such that a current time is displayed by a cumulative amount of activated electronic display areas.

19. The clock of claim 18, wherein said plurality of display areas are arranged in an array so as to form upon activation any dot pattern found on a domino block.

20. The clock of claim 18, wherein said each of said display areas are further configured to blink each second, thereby also displaying seconds on any one of said display areas.

21. A clock comprising:
(a) a time measuring mechanism; and
(b) a plurality of time display areas for displaying a passage of time measured by said time measuring mechanism,
(c) a plurality of shutter arrangements, each of said shutter arrangements being associated with one of said time display areas, each of said shutter arrangements being configured to progressively change a quantity of one of said time display areas visible to an observer, said quantity of a time display area being in proportion to a corresponding portion of an hour having elapsed, thereby displaying a partial or a complete hour by way of any of said time display areas.
